(19) United States
(12) Patent Application Publication
(10) Pub. No.: US 2010/0150104 A1
(43) Pub. Date: Jun. 17, 2010

(54) DEEP PACKET INSPECTION DEVICE AND METHOD

(75) Inventors: Byung Sik YOON, Seo-gu (KR); Man Ho Park, Yuseong-gu (KR); Jung Hak Kim, Yuseong-gu (KR); Song In Choi, Yuseong-gu (KR); Myoung Rak Lee, Seoul (KR); Seung Bin Kim, Seoul (KR); Sung Jun Park, Seoul (KR); Hoh Peter In, Seoul (KR)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute, Daejeon (KR); Korea University Industry and Academy Collaboration Foundation, Seoul (KR)

(21) Appl. No.: 12/388,993

(22) Filed: Feb. 19, 2009

(30) Foreign Application Priority Data
Dec. 17, 2008 (KR) 10-2008-0128732

(51) Int. Cl. H04W 36/00

(52) U.S. Cl. 370/331

(57) ABSTRACT

The present invention relates to a deep packet inspection method and device of a wireless communication system. The deep packet inspection method includes: receiving a first deep packet inspection result for a packet of a terminal from a first subnet before a handover when the handover occurs; receiving a second deep packet inspection result for the packet of the terminal from a second subnet after the handover; and coordinating the first deep packet inspection result and the second deep packet inspection result when the handover occurs.

### CROSS-REFERENCE TO RELATED APPLICATION

This application claims priority to and the benefit of Korean Patent Application No. 10-2008-0128732 filed in the Korean Intellectual Property Office on Dec. 17, 2008, the entire contents of which are incorporated herein by reference.

### BACKGROUND OF THE INVENTION

(a) Field of the Invention

The present invention relates to a deep packet inspection device and method.

(b) Description of the Related Art

Recent wireless communication systems provide a seamless Internet service without service interruptions when a handover occurs because of a user movement. Security threats have also been increased with this development, such as illegal authentication in the radio section, illegal access, packet interruption, and Internet protocol (IP) starvation attacks. As this kind of attack has evolved, security threats in the condition of providing user' mobility are expected to have various forms. Therefore, it is very important to continuously perform deep inspection on specific packets when a handover occurs.

Deep packet inspection (DPI) represents a packet filtering skill for searching contents of packet as well as a header of the packets. It is important to inspect the contents of the packets in the condition in which IP mobility is provided. Deep packet inspection for the conventional cable network has been performed for a single subnet, and it is difficult in the mobile IP supported condition to consecutively monitor and track the packets connected based on a specific mobile unit by using the existing deep packet inspection. Particularly, when a user supporting the mobile IP uses a wired and wireless combined service and handovers are seamlessly generated, it is difficult to continuously track a specific user transmitting and receiving packets including a malicious pattern.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to ceaselessly track a specific user's packets when a handover occurs because of the user's movement.

An exemplary embodiment of the present invention provides a deep packet inspection method of a wireless communication system including: receiving a first deep packet inspection result for a packet of a terminal from a first subnet before a handover when the handover occurs; receiving a second deep packet inspection result for the packet of the terminal from a second subnet after the handover; and coordinating the first deep packet inspection result and the second deep packet inspection result when the handover occurs.

The method further includes receiving an identifier of the terminal from an authentication server; and receiving a care-of address and a home address of the terminal from a home agent.

The receiving of a first deep packet inspection result includes receiving an identifier of the terminal, a care-of address of the first subnet of the terminal, and a home address of the terminal, and the receiving of a second deep packet inspection result includes receiving an identifier of the terminal, a care-of address of the second subnet of the terminal, and a home address of the terminal.

The coordinating includes coordinating the first deep packet inspection result and the second deep packet inspection result into a third deep packet inspection result based on proper information of the terminal.

The proper information includes at least one of an identifier of the terminal, a home address of the terminal, and an Internet protocol (IP) address of the terminal.

The first deep packet inspection result is generated by matching a packet of the terminal and a pattern of a deep packet inspection algorithm in the first subnet, and the second deep packet inspection result is generated by matching a packet of the terminal and a pattern of a deep packet inspection algorithm in the second subnet.

Another embodiment of the present invention provides a deep packet inspection method of a wireless communication system, including: capturing a packet generated by a terminal in a first subnet; generating a deep packet inspection result by matching the captured packet and a pattern of a deep packet inspection algorithm; and transmitting the deep packet inspection result to a deep packet inspection server for managing the first subnet and the second subnet when a handover from the first subnet to the second subnet occurs.

The method further includes: receiving an identifier of the terminal from an authentication server; and receiving a care-of address and a home address of the terminal from a home agent.

The transmitting includes transmitting an identifier of the terminal, a care-of address of the first subnet of the terminal, and a home address of the terminal to the deep packet inspection server.

Yet another embodiment of the present invention provides a deep packet inspection device including: a receiver for receiving a first deep packet inspection result for a packet of a terminal from a first subnet before a handover when the handover occurs, and receiving a second deep packet inspection result for the packet of the terminal from a second subnet after the handover; and a coordinator for generating a third deep packet inspection result by coordinating the first deep packet inspection result and the second deep packet inspection result when the handover occurs.

The device further includes: a first deep packet inspection client, included in the first subnet, for generating the first deep packet inspection result by matching a packet of the terminal and a pattern of an inspecting algorithm; and a second deep packet inspection client, included in the second subnet, for generating the first deep packet inspection result by matching the packet of the terminal and the pattern of the inspecting algorithm.

The coordinator coordinates the first deep packet inspection result and the second deep packet inspection result into a third deep packet inspection result based on proper information of the terminal.

According to an embodiment of the present invention, security threats can be reduced by consecutively tracking a specific user's packets when a handover occurs because of the movement by the user.

### BRIEF DESCRIPTION OF THE DRAWINGS

FIG. 1 shows a block diagram of a wireless portable Internet system including a deep packet inspection device according to an exemplary embodiment of the present invention.

FIG. 2 shows a block diagram of a deep packet inspection device according to an exemplary embodiment of the present invention.

FIG. 3 shows a flowchart for performing deep packet inspection according to an exemplary embodiment of the present invention.

FIG. 4 shows an operation by a deep packet inspection system according to an exemplary embodiment of the present invention when a terminal moves.

FIG. 5 shows a case of coordinating care-of-address-based partial information into home address-based information according to an exemplary embodiment of the present invention.

FIG. 6 shows a process for a coordinator of a deep packet inspection server according to an exemplary embodiment of the present invention to generate a pattern matching result.

FIG. 7 shows a coordinating task according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In the specification, a terminal may indicate a, mobile station (MS), a mobile terminal (MT), a subscriber station (SS), a portable subscriber station (PSS), user equipment (UE), and an access terminal (AT), and it may include entire or partial functions of the mobile station, the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

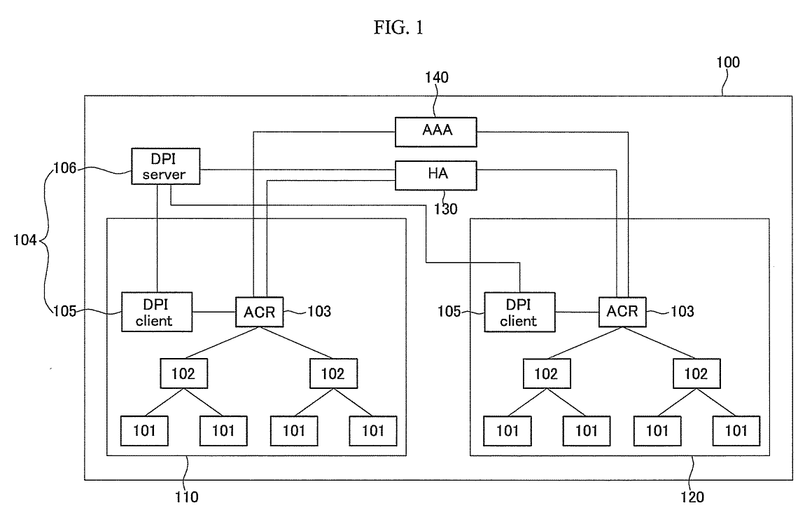

A deep packet inspection device according to an exemplary embodiment of the present invention will now be described with reference to FIG. 1.

FIG. 1 shows a block diagram of a wireless communication system including a deep packet inspection device according to an exemplary embodiment of the present invention.

Referring to FIG. 1, the wireless communication system 100 includes a plurality of subnets 110 and 120, a home agent (HA), and an authentication server 140. The authentication server 140 may be AAA server which supplies functions of authentication, authorization and accounting.

The subnets 110 and 120 respectively include a terminal 101, a base station 102, an access control router (ACR) 103, and a deep packet inspection device 104.

The terminal 101 represents an end point of a radio channel, and it accesses the radio access station 102 to transmit/receive packet data at a high speed by using a transmitting/receiving function and a media access control (MAC) processing function following the radio access standard of a wireless communication system such as a portable Internet system.

The radio access station 102 receives a radio signal from the terminal 101 and transmits it to the access control router 103 or converts the data provided by the access control router 103 into radio signals and transmits them to the terminal 101, and performs an initial access with the terminal 101, a handover control function between sectors, and a Quality of Service (QoS) control function.

The access control router 103 accesses the IP-based core network configuring the Internet through the radio access station 102 and IP-based cable access, and performs authentication, mobile Internet protocol, handover between radio access stations 102, a handover control function between the access control routers 103, and a QoS control function.

The deep packet inspection device 104 includes a deep packet inspection client 105 and a deep packet inspection server 106, and it is connected to the access control router 103 to inspect the packets in the level of the access control router 103. The deep packet inspection client 105 transmits a past deep packet inspection result of the specific terminal 101 to the deep packet inspection server 106 when the terminal 101 communicating in one of the subnets 110 and 120 moves to another of the subnets 110 and 120 to generate a handover.

A home agent 130 registers a home address of the terminal 101, and it registers a care-of address (CoA) when the terminal 101 leaves the corresponding subnets 110 and 120, thereby maintaining current location information of the terminal 101. Also, the home agent 130 encapsulates a datagram so that the terminal 101 may communicate from another subnet 110 and 120 to the subnet 110 or 120 to which the terminal 101 belongs.

The authentication server 140 processes a portable Internet user's computer resource access per service provider, provides authentication, authorization, and accounting service functions, and registers an identifier of the terminal 101.

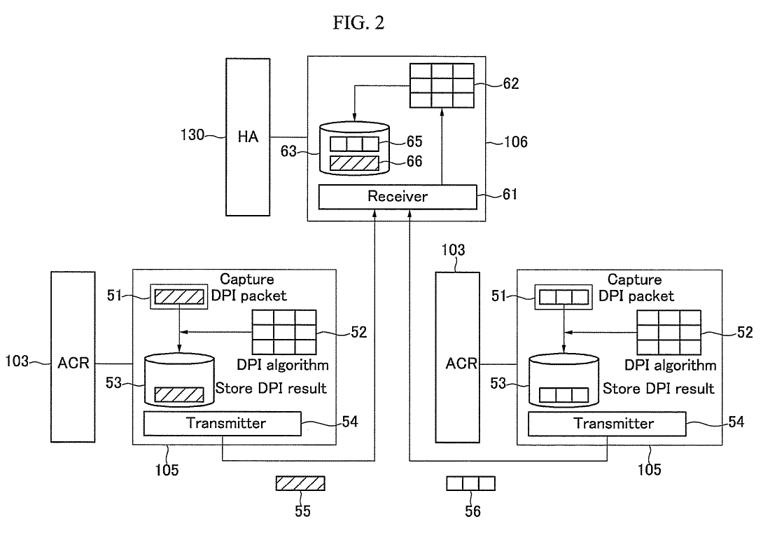

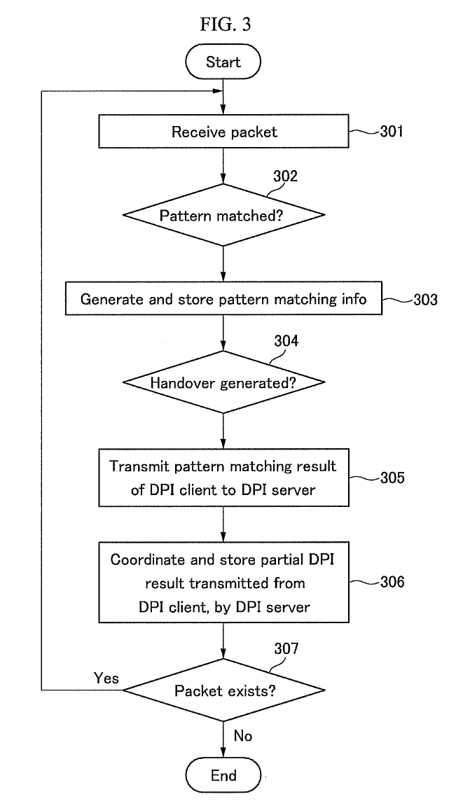

A deep packet inspection device according to an exemplary embodiment of the present invention will now be described with reference to FIG. 2 and FIG. 3.

FIG. 2 shows a block diagram of a deep packet inspection device according to an exemplary embodiment of the present invention, and FIG. 3 shows a flowchart of deep packet inspection according to an exemplary embodiment of the present invention.

Referring to FIG. 2, the deep packet inspection client 105 includes a receiver 51, a pattern matcher 52, a storage unit 53, and a transmitter 54, and the deep packet inspection server 106 includes a receiver 61, a coordinator 62, and a storage unit 63.

The receiver 51 of the deep packet inspection client 105 captures and receives data packets 45 and 46 generated by the terminal 101, receives an identifier and a home address of the terminal 101 from the home agent 130, and receives a care-of address of the terminal 101 from the home agent 130 when the terminal 101 moves.

The pattern matcher 52 pattern matches the received packets 45 and 46 and a stored deep packet inspection algorithm to generate deep packet inspection results 55 and 56.

The storage unit 53 stores the deep packet inspection results 55 and 56.

The transmitter 54 transmits the deep packet inspection result to the deep packet inspection server 106 when a handover occurs. The deep packet inspection result represents the packets 55 and 56 that are matched and transmitted when a terminal 101 moves to different access control routers 102 and 103. In this instance, the transmitter 55 transmits the identifier of the terminal 101, home address, and care-of address to the deep packet inspection server 106 together with the deep packet inspection result.

The receiver 61 of the deep packet inspection server 106 receives the deep packet inspection results 55 and 56, an identifier of the terminal 101, a home address, and a care-of address from the deep packet inspection client 105.

The coordinator 62 coordinates the deep packet inspection results 55 and 56 into proper information of the terminal 101 based on the identifier of the terminal 101, home address, and care-of address, and the storage unit 63 stores the coordinated deep packet inspection results 65 and 66. The proper information includes an IP address, a home address, and an identifier of the terminal.

Referring to FIG. 3, the deep packet inspection client 105 receives a packet (S301). The deep packet inspection client 105 inspects whether the received packet matches the pattern of the deep packet inspection algorithm (S302). When the received packet matches the pattern of the deep packet inspection algorithm, it generates and stores pattern matching information (S303).

When the received packet does not match the pattern of the deep packet inspection algorithm, it determines whether there is a packet in order to compare another packet to the pattern of the deep packet inspection algorithm (S307). When a packet according to the determination result exists, the pattern matching process is performed from the start, and when there is no packet, the process is terminated.

After generating and storing pattern matching information S303, it determines whether a handover occurs (S304). When the handover has occurred, the deep packet inspection client 105 transmits a pattern matching result of the monitored terminal, that is, a deep packet inspection result, to the deep packet inspection server 106 (S305). When no handover has occurred, it starts inspecting another packet rather than transmitting the pattern matching result of the terminal to the deep packet inspection server 106 (S307).

Since the terminal 101 has moved to the subnet 120, the deep packet inspection client 106 follows a handover instruction to transmit a pattern matching result for the packet transmitted by the terminal 101 to the subnet 120 to the deep packet inspection server 106 through the process of S301, S302, S303, and S307.

After the deep packet inspection clients 105 and 106 have transmitted the pattern matching result to the deep packet inspection server 106 (S305), the deep packet inspection server 106 coordinates the pattern matching result provided by the deep packet inspection clients 105 and 106 and stores a coordinated result (S306).

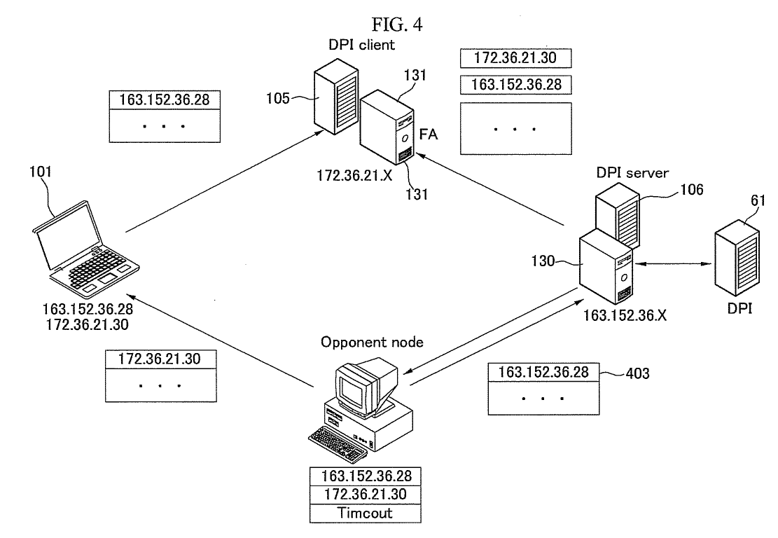

With reference to FIG. 4 to FIG. 7, an operation by the deep packet inspection server 106 will now be described.

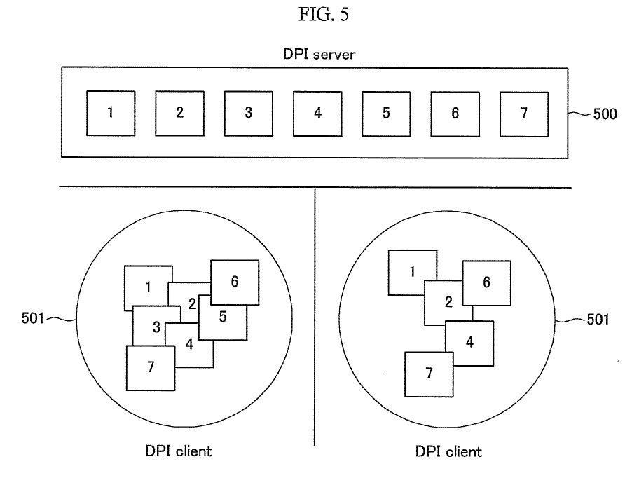

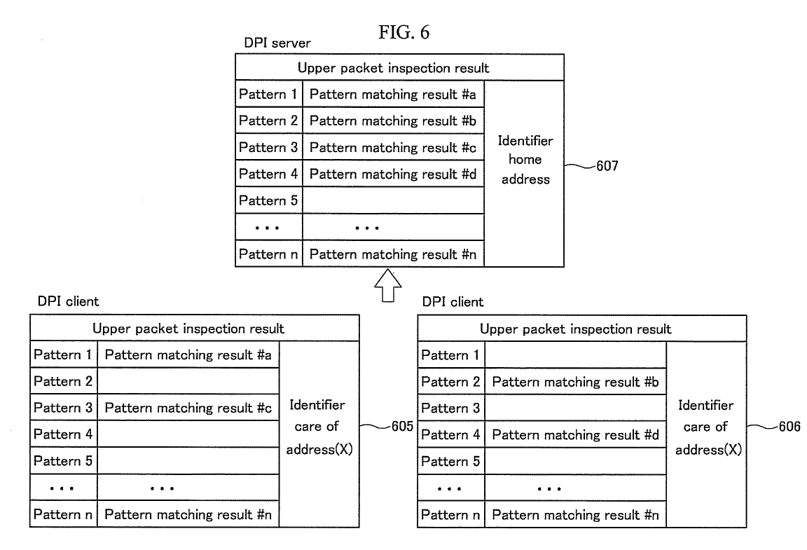

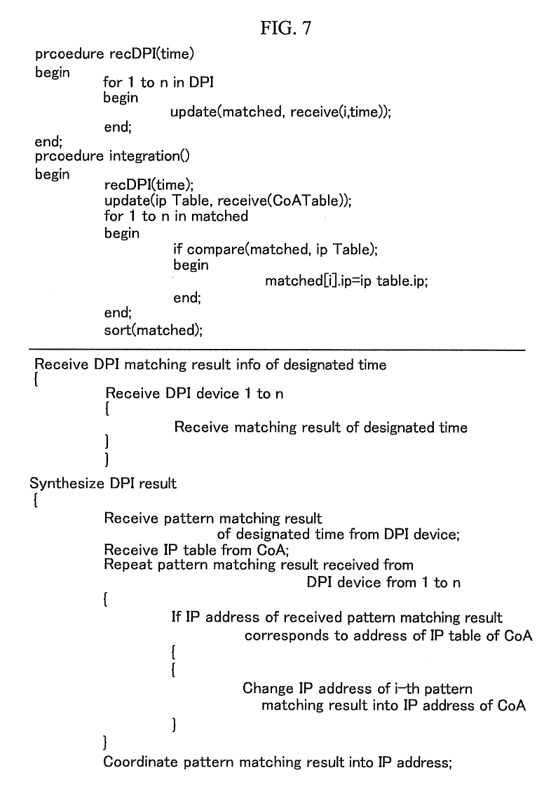

FIG. 4 shows an operation by a deep packet inspection system according to an exemplary embodiment of the present invention when a terminal moves, FIG. 5 shows a case of coordinating care-of address-based partial information into home address-based information according to an exemplary embodiment of the present invention, FIG. 6 shows a process for a coordinator of a deep packet inspection server according to an exemplary embodiment of the present invention to generate a pattern matching result, and FIG. 7 shows a coordinating task according to an exemplary embodiment of the present invention.

Referring to FIG. 4, the terminal 101 has received home addresses 402 and 403 from the home agent 130, and receives new care-of addresses 401 and 404 from the home agent of the area to which the terminal 101 has moved, that is, a foreign agent FA 131. The coordinator 62 of the deep packet inspection server 106 synthesizes care-of addresses 401 and 404 based on packet inspecting results provided by the deep packet inspection client 105 in the area where the moving terminal 101 is located into the home addresses 402 and 403 based on packet inspecting results to generate the packet inspecting results of the same terminal into a combined packet inspecting result.

FIG. 5 illustrates the results 501 and 502 of performing partial deep packet inspection in the area where the deep packet inspection client 105 is located. The partial deep packet inspection results 501 and 502 are synthesized by the deep packet inspection server 106 to generate a complete packet inspecting result 500.

A process for the coordinator 62 to generate a new packet inspecting result in the area of the deep packet inspection server 106 by using the deep packet inspection result performed in the area of the deep packet inspection client 105 when a handover occurs will now be described with reference to FIG. 6.

Referring to FIG. 6, when performing deep packet inspection, the deep packet inspection clients 105 and 106 store an identifier (ID) of the terminal, a care-of address, and logged information that is deep packet inspection results 605 and 606, and they transmit the deep packet inspection results to the area where the deep packet inspection server 106 is located when the terminal's handover occurs.

The deep packet inspection server 106 combines the care-of address-based partial deep packet inspection results by the coordinator 62, and generates a complete deep packet inspection result for the terminal's identifier and/or home address.

FIG. 7 illustrates an algorithm of comparing a care-of address and a home address and extracting the terminal's packet inspecting result into a single IP. The coordinator 62 can generate a complete deep packet inspection result by using the same algorithm as in FIG. 7.

When the handover occurs, the deep packet inspection result is transmitted to the deep packet inspection server to coordinate the deep packet inspection result, and hence packets of a specific terminal can be consecutively tracked when the terminal moves.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A deep packet inspection method of a wireless communication system comprising:
receiving a first deep packet inspection result for a packet of a terminal from a first subnet before a handover when the handover occurs;
receiving a second deep packet inspection result for the packet of the terminal from a second subnet after the handover; and
coordinating the first deep packet inspection result and the second deep packet inspection result when the handover occurs.

2. The deep packet inspection method of claim 1, further including:
receiving an identifier of the terminal from an authentication server; and
receiving a care-of address and a home address of the terminal from a home agent.

3. The deep packet inspection method of claim 1, wherein
the receiving of a first deep packet inspection result comprises receiving an identifier of the terminal, a care-of address of the first subnet of the terminal, and a home address of the terminal, and
the receiving of a second deep packet inspection result comprises receiving an identifier of the terminal, a care-of address of the second subnet of the terminal, and a home address of the terminal.

4. The deep packet inspection method of claim 1, wherein
the coordinating comprises coordinating the first deep packet inspection result and the second deep packet inspection result into a third deep packet inspection result based on proper information of the terminal.

5. The deep packet inspection method of claim 4, wherein
the proper information comprises at least one of an identifier of the terminal, a home address of the terminal, and an Internet protocol (IP) address of the terminal.

6. The deep packet inspection method of claim 1, wherein
the first deep packet inspection result is generated by matching a packet of the terminal and a pattern of a deep packet inspection algorithm in the first subnet, and
the second deep packet inspection result is generated by matching a packet of the terminal and a pattern of a deep packet inspection algorithm in the second subnet.

7. A deep packet inspection method of a wireless communication system comprising:
capturing a packet generated by a terminal in a first subnet;
generating a deep packet inspection result by matching the captured packet and a pattern of a deep packet inspection algorithm; and
transmitting the deep packet inspection result to a deep packet inspection server for managing the first subnet and the second subnet when a handover from the first subnet to the second subnet occurs.

8. The deep packet inspection method of claim 7, further comprising:
receiving an identifier of the terminal from an authentication server; and
receiving a care-of address and a home address of the terminal from a home agent.

9. The deep packet inspection method of claim 7, wherein
the transmitting comprises transmitting an identifier of the terminal, a care-of address of the first subnet of the terminal, and a home address of the terminal to the deep packet inspection server.

10. A deep packet inspection device comprising:
a receiver for receiving a first deep packet inspection result for a packet of a terminal from a first subnet before a handover when the handover occurs, and receiving a second deep packet inspection result for the packet of the terminal from a second subnet after the handover; and
a coordinator for generating a third deep packet inspection result by coordinating the first deep packet inspection result and the second deep packet inspection result when the handover occurs.

11. The deep packet inspection device of claim 10, further including:
a first deep packet inspection client, comprised in the first subnet, for generating the first deep packet inspection result by matching a packet of the terminal and a pattern of an inspecting algorithm; and
a second deep packet inspection client, comprised in the second subnet, for generating the first deep packet inspection result by matching the packet of the terminal and the pattern of the inspecting algorithm.

12. The deep packet inspection device of claim 10, wherein
the coordinator coordinates the first deep packet inspection result and the second deep packet inspection result into a third deep packet inspection result based on proper information of the terminal.
